(19) United States
(12) Patent Application Publication
(10) Pub. No.: US 2018/0107314 A1
(43) Pub. Date: Apr. 19, 2018

(54) TOUCH CONTROL SUBSTRATE AND MANUFACTURING METHOD THEREOF, TOUCH CONTROL DISPLAY PANEL, AND DISPLAY APPARATUS

(71) Applicants: BOE TECHNOLOGY GROUP CO., LTD., Beijing (CN); Chengdu BOE Optoelectronics Technology Co., Ltd., Chengdu (CN)

(72) Inventors: Benlian Wang, Beijing (CN); Zheng Liu, Beijing (CN)

(21) Appl. No.: 15/678,045

(22) Filed: Aug. 15, 2017

(30) Foreign Application Priority Data
Oct. 17, 2016 (CN) 201610901980.1

(51) Int. Cl. G06F 3/041

(52) U.S. Cl. CPC G06F 3/0412; G06F 2203/04103; G06F 3/0416

(57) ABSTRACT

Embodiments of this disclosure relate to a touch control substrate and a manufacturing method thereof, a touch control display panel, and a display apparatus. This touch control substrate comprises: a base substrate; and a patterned touch control electrode layer provided on the base substrate, wherein the surface of the patterned touch control electrode layer departing from the side of the base substrate comprises a roughened surface.

### CROSS REFERENCE TO RELATED APPLICATION

This application claims the priority of the Chinese Application No. 201610901980.1 filed on Oct. 17, 2016, whose total contents are incorporated by reference.

### FIELD OF THE INVENTION

Embodiments of this disclosure generally relate to the technical field of display, and particularly to a touch control substrate and a manufacturing method thereof, a touch control display panel, and a display apparatus.

### BACKGROUND OF THE INVENTION

At present, touch screens have become the input devices having highly wide applications in the technical field of display. The touch screen mainly achieves the touch function by a touch control substrate. In the structure of a conventional touch control substrate, a touch control electrode layer and an insulating layer are sequentially provided on a base substrate, wherein a driving electrode and a sensing electrode, which are separated, are provided in the touch control electrode layer.

The touch control electrode layer in the conventional touch control screen substrate is a patterned ITO sensor layer produced from an ITO transparent conductive material. However, the transparency of ITO is not 100%, and therefore in an environment of strong light such as outdoors, external light will be reflected on the area covered by an ITO pattern and will not be reflected on the area not covered by an ITO pattern. This difference will result in that an apparent ITO pattern can be seen by the user, and the degree of user experience is not high. Most of the existing solutions add an additional optical index matching film on the ITO sensor layer to reduce the visibility of the ITO pattern.

### SUMMARY OF THE INVENTION

According to a first aspect of embodiments of this disclosure, there is provided a touch control substrate, comprising: a base substrate; and a patterned touch control electrode layer provided on the base substrate, wherein the surface of the patterned touch control electrode layer departing from the side of the base substrate comprises a roughened surface.

According to one exemplary embodiment of this disclosure, the touch control electrode layer has a single-layer structure.

According to another exemplary embodiment of this disclosure, the touch control electrode layer has a double-layer structure, wherein the double-layer structure comprises two patterned touch control electrode sub-layers which are separated by an interlayer insulating film in a direction perpendicular to the main surface of the base substrate, and the surface of at least one touch control electrode sub-layer in the touch control electrode layer departing from the side of the base substrate comprises a roughened surface.

In one embodiment, the surface of each touch control electrode sub-layer in the touch control electrode layer departing from the side of the base substrate comprises a roughened surface.

According to one exemplary embodiment of this disclosure, the material of the touch control electrode layer is a transparent conductive oxide.

According to an exemplary embodiment of this disclosure, the transparent conductive oxide comprises one or more of ITO, IZO, IGZO, and ITZO.

According to another exemplary embodiment of this disclosure, the touch control electrode layer is a metal mesh.

According to a second aspect of embodiments of this disclosure, there is provided a manufacturing method for a touch control substrate, comprising the steps of:

forming a patterned touch control electrode layer on a base substrate; and

performing roughening treatment on the surface of the patterned touch control electrode layer departing from the side of the base substrate.

According to one exemplary embodiment of this disclosure, the step of forming a patterned touch control electrode layer on a base substrate comprises forming a touch control electrode layer having a single-layer structure on the base substrate.

According to another exemplary embodiment of this disclosure, the step of forming a patterned touch control electrode layer on a base substrate comprises forming a touch control electrode layer having a double-layer structure on the base substrate, wherein the double-layer structure comprises two patterned touch control electrode sub-layers which are separated by an interlayer insulating film in a direction perpendicular to the main surface of the base substrate, and the roughening treatment comprises roughening the surface of at least one touch control electrode sub-layer in the touch control electrode layer departing from the side of the base substrate. In one embodiment, the roughening treatment comprises roughening the surface of each touch control electrode sub-layer in the touch control electrode layer departing from the side of the base substrate.

According to an exemplary embodiment of this disclosure, the roughening treatment comprises etching the surface of the patterned touch control electrode layer departing from the side of the base substrate by using at least one of dry etching and wet etching.

According to one exemplary embodiment of this disclosure, the roughening treatment comprises: while a photoresist used for patterning the touch control electrode layer is remained, performing dry etching so that a hole is formed in the photoresist on the surface of the touch control electrode layer departing from the side of the base substrate, and then performing wet etching or continuing dry etching so as to etch the surface to comprise a roughened surface.

According to an exemplary embodiment of this disclosure, the step of forming a patterned touch control electrode layer on a base substrate comprises: forming a transparent conductive oxide layer or a metal layer on the base substrate, and then patterning the transparent conductive oxide layer or the metal layer to form a patterned transparent conductive oxide layer or a patterned metal mesh layer.

According to a third aspect of embodiments of this disclosure, there is provided a touch control display panel, comprising: a display panel; and a patterned touch control electrode layer provided on the display panel, wherein the surface of the patterned touch control electrode layer departing from the side of the display panel comprises a roughened surface.

According to one exemplary embodiment of this disclosure, the touch control electrode layer has a single-layer structure.

According to another exemplary embodiment of this disclosure, the touch control electrode layer has a double-layer structure, wherein the double-layer structure comprises two patterned touch control electrode sub-layers which are separated by an interlayer insulating film in a direction perpendicular to the main surface of the display panel, and the surface of at least one touch control electrode sub-layer in the touch control electrode layer departing from the side of the display panel comprises a roughened surface.

In one embodiment, the surface of each touch control electrode sub-layer in the touch control electrode layer departing from the side of the base substrate comprises a roughened surface.

According to one exemplary embodiment of this disclosure, the material of the touch control electrode layer is a transparent conductive oxide.

According to an exemplary embodiment of this disclosure, the transparent conductive oxide comprises one or more of ITO, IZO, IGZO, and ITZO.

According to another exemplary embodiment of this disclosure, the touch control electrode layer is a metal mesh.

According to a fourth aspect of embodiments of this disclosure, there is provided a display apparatus, comprising the touch control substrate according to the first aspect or the touch control display panel according to the third aspect.

### BRIEF DESCRIPTION OF THE DRAWINGS

In order to illustrate the technical solutions in embodiments of this disclosure more clearly, the figures required for describing the embodiments will be simply introduced below. It is apparent that the figures described below are some embodiments of this disclosure, and other figures may be further obtained by the ordinary skilled person in the art according to these figures without exerting inventive work.

FIG. 1 schematically shows a sectional view of a touch control substrate according to one exemplary embodiment of this disclosure;

FIG. 2 schematically shows a sectional view of a touch control substrate according to another exemplary embodiment of this disclosure;

FIG. 3 is a flow chart of a manufacturing method for a touch control substrate according to an embodiment of this disclosure; and

FIGS. 4A-4F show the sectional views of a touch control substrate in various stages of a manufacturing method for a touch control substrate in one example according to an exemplary embodiment of this disclosure.

### DETAILED DESCRIPTION

In order to enable the objects, technical solutions, and the advantages of the embodiments of this disclosure to be clearer, the technical solutions in the embodiments of this disclosure will be described clearly and fully below in conjunction with the accompanying drawings in the embodiments of this disclosure. Obviously, the embodiments described are a part of the embodiments of this disclosure, rather than all of the embodiments. Based on the embodiments in this disclosure, all other embodiments obtained by those of ordinary skill in the art without performing inventive work belong to the scope protected by this disclosure.

According to an exemplary embodiment of this disclosure, there is provided a touch control substrate. This touch control substrate comprises: a base substrate; and a patterned touch control electrode layer provided on the base substrate, wherein the surface of the patterned touch control electrode layer departing from the side of the base substrate comprises a roughened surface.

According to this aspect, when an external light is radiated onto the surface of a touch control electrode layer which is roughened and thus uneven, diffuse reflection occurs and the visibility of the touch control electrode layer is reduced or eliminated, so that the visibility of the touch control electrode layer may be reduced and the display effect of the touch screen is improved without adding an additional optical index matching film.

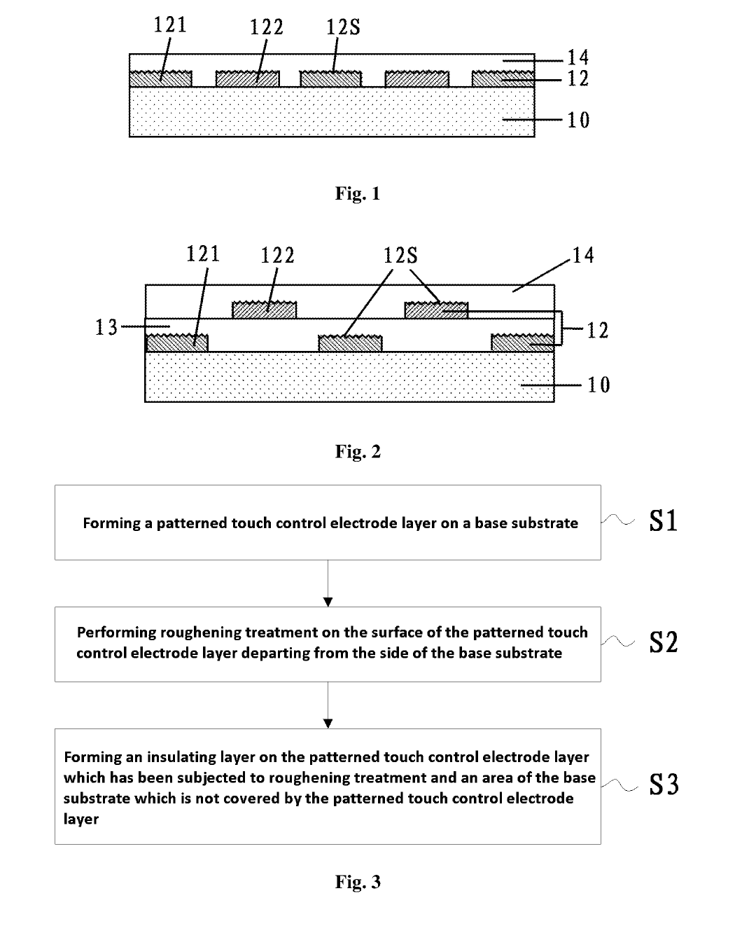

FIG. 1 schematically shows a sectional view of a touch control substrate according to one exemplary embodiment of this disclosure. As shown in FIG. 1, this touch control substrate comprises a base substrate 10 and a patterned touch control electrode layer 12. The patterned touch control electrode layer 12 is provided on the base substrate 10, and the surface 12S of the patterned touch control electrode layer 12 departing from the side of the base substrate comprises a roughened surface.

The touch control substrate may also optionally (but not necessarily) comprise an insulating layer 14. The insulating layer 14 is provided on the patterned touch control electrode layer 12 and an area of the base substrate 10 which is not covered by the patterned touch control electrode layer 12.

Here, the patterned touch control electrode layer 12 is used as a sensor of the touch control substrate. By allowing the surface 12S of the patterned touch control electrode layer 12 departing from the side of the base substrate to comprise a roughened and thus uneven surface, when an external light is radiated onto this uneven surface, diffuse reflection occurs, but not specular reflection which occurs as in the surface of a sensor of a conventional touch control substrate and goes to a human eye to be felt by the user. Therefore, the visibility of the touch control electrode layer is reduced or eliminated, so that the display effect of the touch screen is improved without adding an additional optical index matching film.

The base substrate 10 may be any base substrate useful in a touch screen, and is not limited. The touch control electrode layer 12 may comprise any material having both transparency and conductivity. Furthermore, the insulating layer 14 may be formed from any material having the insulating property.

The material of the touch control electrode layer 12 may be any transparent conductive oxide. For example, the transparent conductive oxide may include one or more of indium tin oxide (ITO), indium zinc oxide (IZO), indium gallium zinc oxide (IGZO), and indium tin zinc oxide (ITZO). Other transparent conductive oxides may be contemplated by the person skilled in the art. According to this embodiment, the transparent conductive oxide can satisfy the requirements for the transmittance and the conductivity of the sensor at the same time, and thus improve the visual quality and the sensitivity of the touch screen.

The touch control electrode layer 12 may also be a metal mesh. The metal mesh can satisfy the requirements for the transmittance and the conductivity of the sensor at the same time and may have a higher conductivity than that of the transparent conductive oxide, and thus can improve the visual quality and the sensitivity of the touch screen.

In the embodiment shown in FIG. 1, the touch control electrode layer 12 is a single-layer structure. In this single-layer structure, an individual touch control electrode layer may comprise a touch control electrode pattern as a driving electrode (one of numerals 121 and 122 in FIG. 1) and a touch control electrode pattern as a sensing electrode (the other of numerals 121 and 122 in FIG. 1), which are provided in the same layer and are separated from each other. The touch control electrode pattern 121 may be alternately arranged with the touch control electrode pattern 122. However, the arrangement and the layout of the touch control electrode pattern 121 and the touch control electrode pattern 122 are not limited in this disclosure, and other arrangements and layouts may be selected by the person skilled in the art as needed.

FIG. 2 schematically shows a sectional view of a touch control substrate according to another exemplary embodiment of this disclosure. As shown in FIG. 2, similarly to the embodiment shown in FIG. 1, this touch control substrate comprises a base substrate 10 and a patterned touch control electrode layer 12. The patterned touch control electrode layer 12 is provided on the base substrate 10, and the surface 12S of the patterned touch control electrode layer 12 departing from the side of the base substrate comprises a roughened surface.

The touch control substrate may also optionally (but not necessarily) comprise an insulating layer 14. The insulating layer 14 is provided on the patterned touch control electrode layer 12 and an area of the base substrate 10 which is not covered by the patterned touch control electrode layer 12.

The difference between the embodiment shown in FIG. 2 and the embodiment shown in FIG. 1 is that the touch control electrode layer 12 in FIG. 2 has a double-layer structure. The double-layer structure comprises two patterned touch control electrode sub-layers which are separated by an interlayer insulating film 13 in a direction perpendicular to the main surface of the base substrate 10. The interlayer insulating film 13 may be formed from any material having the insulating property. In this double-layer structure, the surface 12S of at least one touch control electrode sub-layer of the touch control electrode layer 12 departing from the side of the base substrate comprises a roughened surface. In the embodiment shown in FIG. 2, the surface 12S of each touch control electrode sub-layer of the touch control electrode layer 12 departing from the side of the base substrate comprises a roughened surface.

Therefore, no matter whether the touch control electrode layer as a sensor is a single-layer structure wherein a driving electrode and a sensing electrode are provided in the same layer or a double-layer structure wherein a driving electrode and a sensing electrode are provided in different layers, since diffuse reflection occurs when the surface of at least one sub-layer of the touch control electrode layer is irradiated by external light, the visibility of the touch control electrode layer may be reduced or eliminated.

As with the touch control substrate shown in FIG. 1, by allowing the surface 12S of the patterned touch control electrode layer 12 departing from the side of the base substrate to comprise a roughened and thus uneven surface with respect to the touch control substrate shown in FIG. 2, when external light is radiated onto this uneven surface, diffuse reflection occurs, but not specular reflection which occurs as in the surface of a sensor of a conventional touch control substrate and goes to a human eye to be felt by the user. Therefore, the visibility of the touch control electrode layer is reduced or eliminated, so that the display effect of the touch screen is improved without adding an additional optical index matching film.

As described above, in the embodiment shown in FIG. 2, the touch control electrode layer 12 is a double-layer structure. The double-layer structure comprises two touch control electrode sub-layers which are separated by an interlayer insulating film 13 in a direction perpendicular to the main surface of the base substrate 10. In this double-layer structure, a touch control electrode pattern as a driving electrode (one of numerals 121 and 122 in FIG. 2) and a touch control electrode pattern as a sensing electrode (the other of numerals 121 and 122 in FIG. 2) are provided in two touch control electrode sub-layers respectively. The projection of the touch control electrode pattern 121 on the base substrate 10 may be alternately arranged with the projection of the touch control electrode pattern 122 on the base substrate 10. However, the arrangement and the layout of the touch control electrode pattern 121 and the touch control electrode pattern 122 are not limited in this disclosure, and other arrangements and layouts may be selected by the person skilled in the art as needed.

An embodiment of this disclosure also provides a manufacturing method for a touch control substrate, comprising the steps of:

forming a patterned touch control electrode layer on a base substrate; and

performing roughening treatment on the surface of the patterned touch control electrode layer departing from the side of the base substrate.

According to this aspect, a touch control substrate having a roughened touch control electrode layer surface can be provided. When an external light is radiated onto the surface of a touch control electrode layer which is roughened and thus uneven, diffuse reflection occurs and the visibility of the touch control electrode layer is reduced or eliminated, so that the display effect of the touch screen is improved without adding an additional optical index matching film.

FIG. 3 is a flow chart of a manufacturing method for a touch control substrate according to an embodiment of this disclosure. As shown in FIG. 3, the manufacturing method for a touch control substrate according to this embodiment comprises the steps of:

forming a patterned touch control electrode layer on a base substrate (Step S1); and

performing roughening treatment on the surface of the patterned touch control electrode layer departing from the side of the base substrate (Step S2).

According to an exemplary embodiment, the manufacturing method for a touch control substrate may also optionally (but not necessarily) comprises forming an insulating layer on the patterned touch control electrode layer which has been subjected to roughening treatment and an area of the base substrate which is not covered by the patterned touch control electrode layer (Step S3).

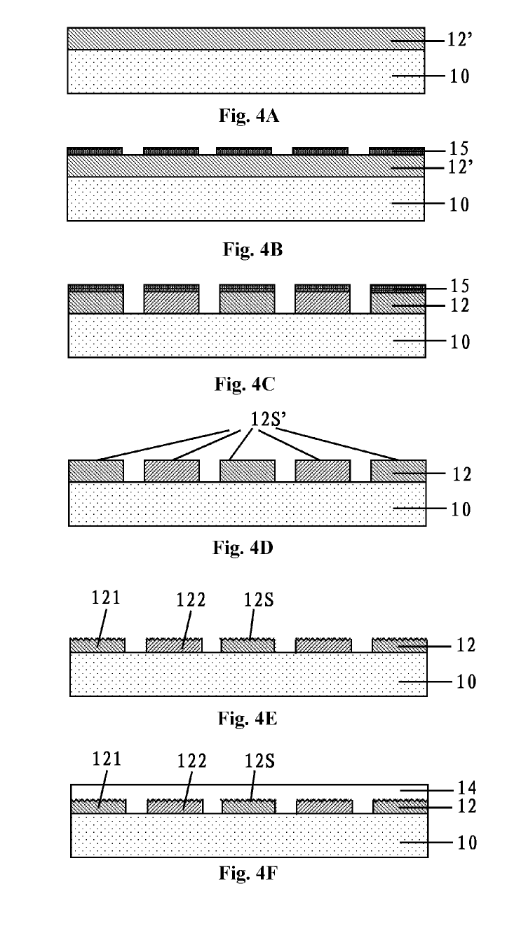

FIGS. 4A-4F show the sectional views of a touch control substrate in various stages of a manufacturing method for a touch control substrate in one example. The manufacturing method for a touch control substrate according to an exemplary embodiment of this disclosure will be described below in conjunction with FIG. 3 and FIGS. 4A-4F. The person skilled in the art will understand that the example shown in FIGS. 4A-4F is merely one specific example of the implementation of a manufacturing method of a touch control substrate in this disclosure, but this disclosure is not limited thereto.

As shown in FIG. 4A, in this specific example, a touch control electrode layer 12′ is formed on the base substrate 10. Then, as shown in FIG. 4B, a patterned photoresist layer 15 is formed on the touch control electrode layer 12′. Subsequently, as shown in FIG. 4C, the pattern of the patterned photoresist layer 15 is transferred onto the touch control electrode layer 12′. That is, the touch control electrode layer 12′ is patterned so as to form a patterned touch control electrode layer 12. Thereby, Step S1 in FIG. 3 is achieved.

Thereafter, as shown in FIG. 4D, the residual photoresist layer 15 may be optionally (but not necessarily) removed.

Then, as shown in FIG. 4E, roughening treatment is performed on the surface 12S′ of the patterned touch control electrode layer 12 departing from the side of the base substrate. Specifically, the surface 12S′ of the patterned touch control electrode layer 12 departing from the side of the base substrate may be etched by using at least one of dry etching and wet etching to achieve this roughening treatment. According to this exemplary embodiment, by roughening using an etching method, the process is mature and the controllability is high. Thereby, Step S2 in FIG. 3 is achieved.

For instance, in an example, after the photoresist layer 15 is removed, the patterned touch control electrode layer 12 is subjected to dry etching or wet etching, until a required thickness of the touch control electrode layer is achieved. Otherwise, in another example, dry etching (such as, the ashing process or the like) may be performed without removing the residual photoresist layer 15 to thin the photoresist layer 15 so as to form a hole in the photoresist on the touch control electrode pattern 121/122, and then wet etching is performed or dry etching is continued to etch the touch control electrode pattern 121/122 to allow the surface 12S thereof to be formed to comprise a roughened surface. However, the mode of roughening treatment is not particularly limited in this disclosure. For example, the surface 12S of the patterned touch control electrode layer 12 departing from the side of the base substrate may be etched by using one of dry etching and wet etching or any combination thereof.

Next, as shown in FIG. 4F, an insulating layer 14, as a protective film for the patterned touch control electrode layer 12, may be optionally (but not necessarily) formed on the patterned touch control electrode layer 12 which has been subjected to roughening treatment and an area of the base substrate 10 which is not covered by the patterned touch control electrode layer 12. Thereby, Step S3 in FIG. 3 is achieved.

It is to be noted in examples shown in FIGS. 4A-4F that the touch control substrate finally formed (see FIG. 4F) is the touch control substrate of the touch control electrode layer 12 having a single-layer structure shown in FIG. 1. Although the touch control electrode patterns used as a driving electrode and a sensing electrode are denoted by different reference numerals 121 and 122 respectively in FIG. 4F, the touch control electrode pattern 121 and the touch control electrode pattern 122 may be touch control electrode patterns which are produced synchronously by using the same process.

With respect to the touch control substrate of the touch control electrode layer 12 having a double-layer structure shown in FIG. 2, in the production method thereof, the roughening treatment (Step S2) comprises roughening the surface 12S of at least one touch control electrode sub-layer in the touch control electrode layer 12 departing from the side of the base substrate. In one embodiment, the roughening treatment (Step S2) comprises respectively roughening the surface 12S of each touch control electrode sub-layer in the touch control electrode layer 12 departing from the side of the base substrate.

In one exemplary embodiment, Step S1 may comprise forming a transparent conductive oxide layer on a base substrate 10 and then patterning the conductive oxide layer so as to form a patterned transparent conductive oxide layer. The transparent conductive oxide may comprise one or more of ITO, IZO, IGZO, and ITZO.

In another exemplary embodiment, Step S1 may comprise forming a metal layer on a base substrate 10 and then patterning the metal layer so as to form a patterned metal mesh layer.

According to this exemplary embodiment, when the transparent conductive oxide is used as the material which forms the touch control electrode layer, it can satisfy the requirements for the transmittance and the conductivity of the sensor at the same time, and thus improve the visual quality and the sensitivity of the touch screen. On the other hand, when the metal mesh is used as the touch control electrode layer, since the metal mesh can satisfy the requirements for the transmittance and the conductivity of the sensor at the same time and may have a higher conductivity than that of the transparent conductive oxide, it can also improve the visual quality and the sensitivity of the touch screen.

Furthermore, an embodiment of this disclosure also provides a touch control display panel, comprising: a display panel; and a patterned touch control electrode layer provided on the display panel, wherein the surface of the patterned touch control electrode layer departing from the side of the display panel comprises a roughened surface.

In one exemplary embodiment, the touch control electrode layer has a single-layer structure.

In one exemplary embodiment, the touch control electrode layer has a double-layer structure, the double-layer structure comprises two patterned touch control electrode sub-layers which are separated by an interlayer insulating film in a direction perpendicular to the main surface of the display panel, and the surface of at least one touch control electrode sub-layer in the touch control electrode layer departing from the side of the display panel comprises a roughened surface.

By allowing the surface of the patterned touch control electrode layer departing from the side of the base substrate or the display panel to comprise a roughened surface in the display panel in this embodiment, the apparent pattern of the touch control electrode layer may be prevented from being seen by the user in an environment of strong light, so that the display effect of the touch screen is improved without adding an additional optical index matching film. It is to be indicated that the display panel in this embodiment may be a liquid crystal display panel or an organic electroluminescent display panel and the touch control electrode layer may be directly produced on the display panel described above so as to achieve touch control display. Furthermore, an embodiment of this disclosure also provides a display apparatus, comprising the touch control substrate described above or the touch control display panel described above.

As described above, by allowing the surface of the patterned touch control electrode layer departing from the side of the base substrate or the display panel to comprise a roughened surface in the touch control substrate or the display panel in embodiments of this disclosure, the apparent pattern of the touch control electrode layer may be prevented from being seen by the user in an environment of strong light, so that the display effect of the touch screen is improved without adding an additional optical index matching film.

A large number of particular details are illustrated in the specification of this disclosure. However, it can be understood that the embodiments of this disclosure may be implemented in absence of these particular details. In some examples, the well-known methods, structures, and techniques are not illustrated in detail so as not to blur the understanding of this specification.

Finally, it is to be indicated that the above embodiments are only to describe the technical solutions of this disclosure rather than limitation. Although this present disclosure has been described in detail with reference to the aforementioned embodiments, it is to be understood by the ordinary skilled person in the art that modifications and combinations may still be performed on the technical solutions recorded by the aforementioned embodiments or equivalent replacements may be performed on a part of the technical features therein. Moreover, the natures of corresponding technical solutions will not depart from the spirit and the scope of the technical solutions of the embodiments in this present disclosure by these modifications, combinations, or replacements.

What is claimed is:

1. A touch control substrate, comprising:
a base substrate; and
a patterned touch control electrode layer provided on the base substrate, wherein a surface of the patterned touch control electrode layer departing from a side of the base substrate comprises a roughened surface.

2. The touch control substrate according to claim 1, wherein the touch control electrode layer has a single-layer structure.

3. The touch control substrate according to claim 1, wherein the touch control electrode layer has a double-layer structure, wherein the double-layer structure comprises two patterned touch control electrode sub-layers which are separated by an interlayer insulating film in a direction perpendicular to a main surface of the base substrate, and the surface of at least one touch control electrode sub-layer in the touch control electrode layer departing from the side of the base substrate comprises a roughened surface.

4. The touch control substrate according to claim 3, wherein the surface of each touch control electrode sub-layer in the touch control electrode layer departing from the side of the base substrate comprises a roughened surface.

5. The touch control substrate according to claim 1, wherein a material of the touch control electrode layer is a transparent conductive oxide.

6. The touch control substrate according to claim 5, wherein the transparent conductive oxide comprises one or more of indium tin oxide (ITO), indium zinc oxide (IZO), indium gallium zinc oxide (IGZO), and indium tin zinc oxide (ITZO).

7. The touch control substrate according to claim 1, wherein the touch control electrode layer is a metal mesh.

8. A manufacturing method for a touch control substrate, comprising the steps of:
forming a patterned touch control electrode layer on a base substrate; and
performing roughening treatment on a surface of the patterned touch control electrode layer departing from a side of the base substrate.

9. The manufacturing method according to claim 8, wherein forming the patterned touch control electrode layer on the base substrate comprises forming the touch control electrode layer having a single-layer structure on the base substrate.

10. The manufacturing method according to claim 8, wherein forming the patterned touch control electrode layer on the base substrate comprises forming the touch control electrode layer having a double-layer structure on the base substrate, wherein the double-layer structure comprises two patterned touch control electrode sub-layers which are separated by an interlayer insulating film in a direction perpendicular to a main surface of the base substrate, and the roughening treatment comprises roughening the surface of at least one touch control electrode sub-layer in the touch control electrode layer departing from the side of the base substrate.

11. The manufacturing method according to claim 9, wherein the roughening treatment comprises roughening the surface of each touch control electrode sub-layer in the touch control electrode layer departing from the side of the base substrate.

12. The manufacturing method according to claim 8, wherein the roughening treatment comprises etching the surface of the patterned touch control electrode layer departing from the side of the base substrate by using at least one of dry etching and wet etching.

13. The manufacturing method according to claim 8, wherein the roughening treatment comprises:
while a photoresist used for patterning the touch control electrode layer is remained, performing dry etching so that a hole is formed in the photoresist on the surface of the touch control electrode layer departing from the side of the base substrate, and
then performing wet etching or continuing dry etching so as to etch the surface to comprise a roughened surface.

14. A touch control display panel, comprising:
a display panel; and
a patterned touch control electrode layer provided on the display panel, wherein a surface of the patterned touch control electrode layer departing from a side of the display panel comprises a roughened surface.

15. The touch control display panel according to claim 14, wherein the touch control electrode layer has a single-layer structure.

16. The touch control display panel according to claim 14, wherein the touch control electrode layer has a double-layer structure, wherein the double-layer structure comprises two patterned touch control electrode sub-layers which are separated by an interlayer insulating film in a direction perpendicular to the main surface of the display panel, and the surface of at least one touch control electrode sub-layer in the touch control electrode layer departing from the side of the base substrate comprises a roughened surface.

17. The touch control display panel according to claim 16, wherein the surface of each touch control electrode sub-layer in the touch control electrode layer departing from the side of the base substrate comprises a roughened surface.

18. The touch control display panel according to claim 14, wherein a material of the touch control electrode layer is a transparent conductive oxide.

19. A display apparatus, comprising the touch control substrate as claimed in claim 1.

20. A display apparatus, comprising the touch control display panel as claimed in claim 14.
